(19) United States
(12) Patent Application Publication
(10) Pub. No.: US 2025/0301525 A1
(43) Pub. Date: Sep. 25, 2025

(54) Channel Management Method for Concurrent Networks and Device Capable of Achieving Optimal Overall Performance

(71) Applicant: MEDIATEK INC., Hsinchu City (TW)

(72) Inventors: Jen-Chieh Liu, Hsinchu City (TW); Liang-Cheng Lai, Hsinchu City (TW); Po-Hui Wang, Hsinchu City (TW); Chun-Hao Chang, Hsinchu City (TW)

(73) Assignee: MEDIATEK INC., Hsinchu City (TW)

(21) Appl. No.: 19/086,166

(22) Filed: Mar. 21, 2025

Related U.S. Application Data
(60) Provisional application No. 63/569,254, filed on Mar. 25, 2024.

(51) Int. Cl. H04W 76/16; H04W 8/00; H04W 60/04

(52) U.S. Cl. CPC H04W 76/16; H04W 8/005; H04W 60/04

(57) ABSTRACT

A channel management method for concurrent networks, performed by a wireless device includes establishing a first connection in a first network with a first communication device through a first channel, and establishing a second connection in a second network with a second communication device through a second channel. The second network is the same as or different from the first network. The second channel is determined by an enhancement channel selection algorithm that takes into account the existence of the first channel through which the first connection has been established.

### CROSS REFERENCE TO RELATED APPLICATIONS

This application claims the benefit of U.S. Provisional Application No. 63/569,254, filed on Mar. 25, 2024. The content of the application is incorporated herein by reference.

### BACKGROUND

The number of Wi-Fi communication devices has increased significantly in recent years, along with the rise of demanding applications such as augmented reality (AR) and virtual reality (VR), leading to an increase in scenarios where multiple Wi-Fi networks are used concurrently. Traditionally, Wi-Fi network connection algorithms have relied on internal criteria for peer selection, for example, for a Wi-Fi Station (STA) network, the algorithm may be related to the following parameters, such as received signal strength indicator (RSSI), interference levels, bandwidth and frequency band (e.g., 2.4 GHz or 5 GHz or 6 GHz). The devices scan available access points (APs), evaluate them based on these criteria (i.e., a regular channel selection algorithm), and select the AP with the highest score. However, this approach may not be optimal for overall system performance, especially in scenarios with multiple concurrent networks.

For instance, in a scenario with a device supporting both Wi-Fi Station (STA) network and Wi-Fi Direct network, the device may first establish a peer-to-peer (P2P) connection on a specific channel based on the P2P protocol's negotiation mechanism. Subsequently, the device may also use the regular channel selection algorithm to connect to an AP for STA operation, which can lead to a Multi-Channel Concurrent (MCC) scenario, causing reduced throughput and increased latency.

These methods also have limitations in scenarios with multiple concurrent networks of the same type. For example, if a device needs to access two P2P networks, it may establish connections on different channels based on individual preferences, leading to MCC and suboptimal performance.

Therefore, improved channel management techniques are needed to improve overall system performance in scenarios with multiple concurrent networks.

### SUMMARY

In an embodiment, a channel management method for concurrent networks is disclosed. The channel management method is performed by a wireless device. The channel management method comprises establishing a first connection in a first network with a first communication device through a first channel, and establishing a second connection in a second network with a second communication device through a second channel. The second network is the same as or different from the first network. The second channel is determined by an enhancement channel selection algorithm that takes into account the existence of the first channel through which the first connection has been established.

In another embodiment, a wireless device is disclosed. The wireless device comprises at least one transceiver and a processor, wherein the at least one transceiver is configured to wirelessly communicate, and the processor is coupled to the at least one transceiver and configured to perform operations: establishing a first connection in a first network with a first communication device through a first channel and establishing a second connection in a second network with a second communication device through a second channel. The second network is the same as or different from the first network. The second channel is determined by an enhancement channel selection algorithm that takes into account the existence of the first channel through which the first connection has been established.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a channel management system according to an embodiment of the present invention.

FIG. 2 is a schematic diagram of the hardware architecture of the channel management system in FIG. 1.

FIG. 3 is a schematic diagram of selecting a second channel from available channels by using an enhancement channel selection algorithm.

FIG. 4 is a schematic diagram of switching the first channel to a third channel of the channel management system in FIG. 1.

FIG. 5 is a flow chart of performing a channel management method for concurrent networks by the channel management system in FIG. 1.

### DETAILED DESCRIPTION

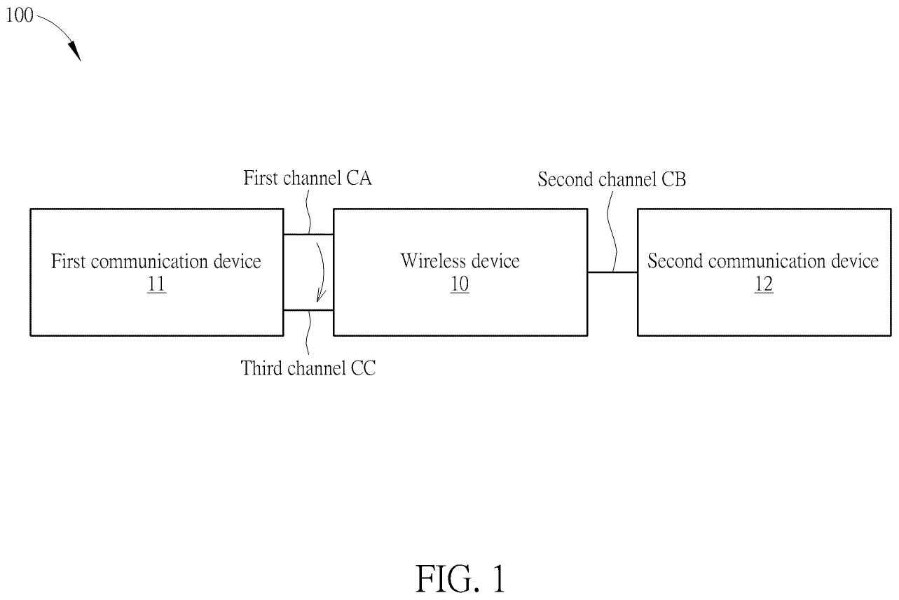

FIG. 1 is a block diagram of a channel management system 100 for concurrent networks (in particular, concurrent Wi-Fi networks) according to an embodiment of the present invention. It is noted that Wi-Fi is a wireless local area network (WLAN) technology based on the IEEE 802.11 standard. For example, different types of networks based on Wi-Fi (IEEE 802.11 standard) can include a station-to-access point (STA-AP) network, a peer-to-peer (P2P) network, a service access point (SAP) network, etc. For the sake of illustration and understanding, embodiments of the present disclosure will be described using the STA-AP network and P2P network as examples but are not limited thereto. For example, the concurrent networks can be a scenario where a P2P network is concurrent with another P2P network, a scenario where an STA-AP network is concurrent with an SAP network, or a scenario where more than two Wi-Fi networks are concurrent, etc. The channel management system 100 can optimize the overall performance of concurrent networks in scenarios where multiple Wi-Fi networks are operating concurrently. The channel management system 100 can further address the issue of a multiple channel concurrent (MCC) scenario (i.e., the scenario where a single device operates in the MCC mode), where a wireless device is connected to multiple networks simultaneously, leading to reduced overall performance due to channel switching overhead and interference. The MCC mode in one wireless device refers to a mode that uses multiple channels and the same (shared) transceiver path to transmit signals for multiple networks, such as through TDD (Time Division Duplexing) by switching channels. The channel management system 100 improves overall performance of concurrent networks by employing an enhancement channel selection algorithm (also referred to as a first channel selection algorithm) that considers the potential for the MCC scenario or the existence of channels used by existing connections when choosing an access point (AP) or channel for a new network connection. In a regular channel selection algorithm (also referred to as a second channel selection algorithm), the potential for the MCC scenario or the existence of channels used by existing connections is not considered. That is, in the regular channel selection algorithm, when selecting an operating channel for a new network connection, it does not consider the existence of channels already used by existing network connections, i.e., each channel selection for a new network connection is done independently and is not affected by the channels used by existing network connections. In the embodiment, the enhancement channel selection algorithm prioritizes a single channel contention (SCC) scenario (i.e., the scenario where the device operates in the SCC mode) or dual-band dual-concurrent (DBDC) scenario (i.e., the scenario where the device operates in the DBDC mode), where the concurrent networks operate on the same channel or different bands, respectively. In the concurrent networks, the wireless device operating in SCC mode or DBDC mode do not need to switch channels for different networks. For instance, in DBDC mode, different networks transmit data through channels in different frequency bands. Similarly, in SCC mode, the wireless device can fully utilize internal TRX (transceiver) hardware resources and different networks transmit through the same channel without channel switching (e.g., different networks use the same channel at different times as needed). However, in MCC mode, the wireless device can only perform TRX for a specific network during the time allocated to the specific network, and if the specific network's TRX is not in use (idle), this idle time cannot be shared with other networks. Therefore, the channel management system 100 offers several advantages, including reduced latency, improved throughput, and enhanced overall system performance in multi-network concurrent scenarios. The SCC mode in a single device refers to a mode that uses a single channel (also referred as an SCC channel) and the same (shared) transceiver path to transmit signals for multiple networks, such as transmitting signals for different networks at different times through the TDD (time division duplex). In addition, the DBDC mode in a single device refers to a mode that uses different channels (also referred to as FDD channels) and different transceiver paths to transmit signals for multiple networks, such as through FDD (frequency division duplex), allowing concurrent communication over the different channels in different frequency bands (such as, 2.4 GHz+5 GHZ, or 2.4 GHz+6 GHz, or 5 GHz+6 GHz).

In FIG. 1, the channel management system 100 includes a wireless device 10, a first communication device 11, and a second communication device 12, wherein the first communication device 11 and the second communication device 12 are respectively connected to the wireless device 10. The wireless device 10 is a mobile device or any user equipment (UE). The wireless device 10 can act as a communication hub, connecting to multiple devices through at least one channel. In the embodiment, the wireless device 10 primarily functions to establish and manage concurrent connections with other devices while reducing or avoiding performance degradation caused by the MCC scenario. The first communication device 11 can be a peer-to-peer (P2P) device, a mobile device, or any other type of communication device. The first communication device 11 establishes a connection with the wireless device 10. The first communication device 11 communicates with the wireless device 10 over a wireless channel. The first communication device 11 transmits and receives data to and from the wireless device 10. The first communication device 11 can also establish a connection with other devices in the network. The second communication device 12 can be an AP, a smartphone, a laptop, or another P2P device, that establishes a connection with the wireless device 10.

In the embodiment, a “connection” refers to a specific communication pathway over which wireless signals are transmitted and received between devices through a channel. For example, each channel can be identified by a channel number (CH) and a corresponding bandwidth. Proper channel selection is crucial for maintaining optimal network performance. Improper channel selection can lead to interference and reduced throughput. Therefore, the channel management system 100 employs the enhancement channel selection algorithm to avoid the MCC scenario in the wireless device 10 as much as possible when choosing a channel for a new network connection.

In FIG. 1, a first connection is established between the wireless device 10 (such as the mobile device) and the first communication device 11 (such as another mobile device) through a first channel CA. A second connection is established between the wireless device 10 and the second communication device 12 through a second channel CB, wherein the second channel CB is selected or determined after the first connection through the first channel CA has been established. The selection of the second channel CB is based on the enhancement channel selection algorithm that considers the existence of the first channel CA used by the existing first connection and aims to optimize overall system performance. Further, in another embodiment, if the wireless device 10 operates in the MCC scenario, the first channel CA between the wireless device 10 and the first communication device 11 can be switched to a third channel CC to avoid operating in the MCC scenario. The third channel CC can be selected to enable the wireless device 10 to operate in the SCC scenario or the DBDC scenario to achieve concurrency with the second channel CB. For example, the third channel CC is determined to be the same as the second channel CB to achieve concurrency in the SCC scenario, for another example, the third channel CC is determined to be a channel (the FDD channel for the second channel CB) in a different frequency band from the second channel CB to achieve concurrency in the DBDC scenario. By doing so, the channel management system 100 employs the enhancement channel selection algorithm to provide improved throughput and reduced latency.

In the channel management system 100, the wireless device 10 establishes the first connection in the first network with the first communication device 11 through the first channel CA, and the wireless device 10 establishes the second connection in the second network with the second communication device 12 through the second channel CB, wherein the second network is the same as or different from the first network. The second channel CB is determined by the enhancement channel selection algorithm that takes into account the existence of the first channel CA through which the first connection has been established. For example, the second channel CB is selected to enable the wireless device 10 to operate in the SCC mode or DBDC mode as much as possible, to achieve concurrency with the first channel CA in the SCC scenario or the DBDC scenario. If the MCC scenario occurs for the wireless device 10, the first channel CA used by the first connection may be switched, for example, the third channel CC is selected by the enhancement channel selection algorithm that takes into account the existence of the second channel CB and the connection between the wireless device 10 and the first communication device 11 is re-established through the third channel CC to enable the wireless device 10 to operate in the SCC scenario or the DBDC scenario. Details of channel management system 100 are illustrated below.

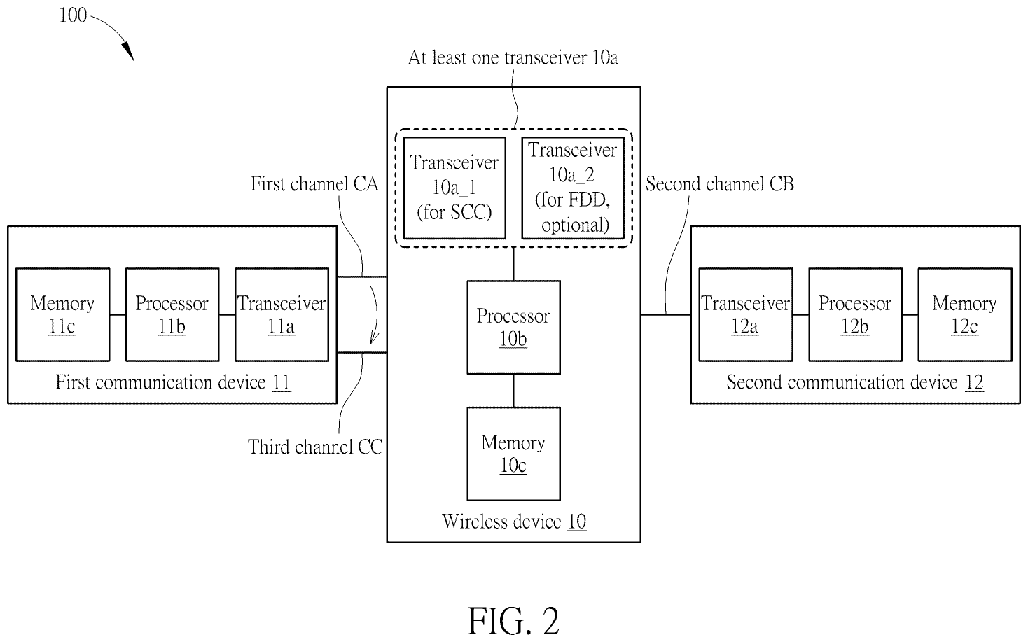

FIG. 2 is a schematic diagram of the hardware architecture of the channel management system 100. The first communication device 11 includes a transceiver 11a, a processor 11b, and a memory 11c. The processor 11b is coupled to the transceiver 11a and the memory 11c. The transceiver 11a enables wireless communication, such as to transmit and receive data over the first connection in the first network through the first channel CA. The processor 11b manages the communication processes, for example, executes a negotiation process with the wireless device 10 to implement the channel selection and switching. The memory 11c stores the necessary software and data for the first communication 11's operation. The second communication device 12 includes a transceiver 12a, a processor 12b, and a memory 12c. The processor 12b is coupled to the transceiver 12a and the memory 12c. The transceiver 12a enables wireless communication, such as to transmit and receive data over the second connection in the second network through the second channel CB. The processor 12b manages the communication processes, for example, executes a negotiation process with the wireless device 10 to implement the channel selection and switching. The wireless device 10 includes at least one transceiver 10a, a processor 10b, and a memory 10c. The processor 10b is coupled to the transceiver 10a and the memory 10c. The processor 10b manages the communication processes, for example, executes negotiation processes with the first communication device 11 and the second communication device 12 to implement the communication (comprising channel selection and switching) with the first communication device 11 and the second communication device 12. The memory 10c stores the necessary software and data for the wireless device 10's operation. Specifically, the wireless device 10 includes at least one transceiver 10a to enable wireless communication, such as to transmit and receive data. If the wireless device 10 comprises only one transceiver 10a_1, it implies that only a single radio frequency (RF) transceiver path is available for the wireless device 10. Therefore, the wireless device 10 can be used to achieve the SCC scenario with the first communication device 11 and the second communication device 12, that is, the wireless device 10 is preferably operated in SCC mode in the concurrent networks. If the wireless device 10 comprises at least two transceivers 10a_1 and 10a_2, it implies that at least two RF transceiver paths are available for the wireless device 10. Therefore, the wireless device 10 can be used to achieve the DBDC scenario (also referred to as an FDD scenario) or the SCC scenario with the first communication device 11 and the second communication device 12. In the embodiment of the present disclosure, the transceiver 10a_2 is optional.

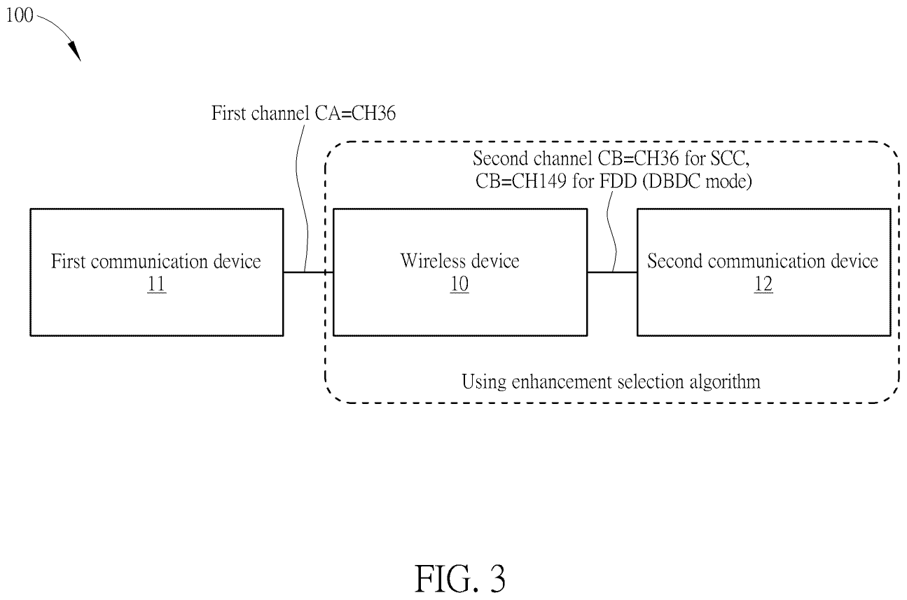

FIG. 3 is a schematic diagram of selecting the second channel CB from available channels by using the enhancement channel selection algorithm. In the embodiment, the first communication device 11 can be a P2P device. The first connection in the first network (such as P2P network) between the wireless device 10 and the first communication device 11 is used for accessing data through the first channel CA. In the example of FIG. 3, the wireless device 10 establishes the first connection with the first communication device 11 through the first channel CA, which is CH36 (i.e., CA=CH36). For example, the wireless device 10 and the first communication device 11 can negotiate and agree to use the first channel CA(=CH36) as the initial operating channel. During the negotiation process, both devices 10 and 11 exchange information about their preferred channels, preferred channel lists and supported channel list. Understandably, one device's preferred channel comprises the channel that the preferred channel expected by the device, while the device's preferred channel list comprises the sub-preferred channels of the device. The device's supported channel list includes all the channels supported by the device. Finally, the group owner (GO) in the P2P network may determine the first channel CA from the available channels based on this information. For example, in the example of FIG. 3, the first channel CA is determined to be CH36. After the P2P connection is established between the wireless device 10 and the first communication device 11 by the first channel CA(=CH36), when a new network connection is to be established later, the enhancement channel selection algorithm for different network types provided by the present invention is used to select a suitable channel for the new network connection.

In one embodiment, the second network is a station-to-access point (STA-AP) network. The wireless device 10 performs a scan operation to discover a plurality of APs on available channels. Each of the plurality of APs has a corresponding operating channel. For example, the wireless device 10 scans a plurality of APs operating in channels CH1, CH36, CH52, CH100, and CH144 respectively, and thus finds a suitable AP from among these APs for connection. Specifically, the wireless device 10 will first generate a plurality of scores corresponding to the plurality of APs according to a regular channel selection algorithm which does not take into account the existence of the channels of existing networks (such as, the first channel CA) or the MCC scenario is not considered. Each of the plurality of scores is associated with a corresponding AP and a corresponding channel. For example, the wireless device 10 generates a score for each AP. Each score is weighted including, for example, based on a variety of factors, such as the signal strength of the AP, the number of devices connected to the AP, and the security of the AP. Each score is a numerical value that represents the desirability of connecting to the corresponding AP. In the proposed enhanced channel selection algorithm, the wireless device 10 further adjusts at least one score corresponding to at least one AP based on the first channel to update the multiple scores initially obtained, aiming to reduce the possibility of the wireless device 10 operating in the MCC mode/scenario. For example, the wireless device 10 decreases at least one score corresponding to at least one AP based on a weighting factor, wherein the weighting factor is greater than 0 and less than 1. Finally, the wireless device 10 selects a highest-scored AP based on a plurality of updated scores for establishing a connection with the highest-scored AP through its operating channel.

In the first case where the wireless device 10 comprises only a single RF transceiver path, the wireless device 10 may decrease at least one score corresponding to at least one AP whose operating channel is different from the first channel CA based on a weighting factor. For example, when the plurality of APs operating in channels CH1, CH36, CH52, CH100, and CH144 are scanned and the first channel CA is CH36, the at least one score to be adjusted may correspond to the at least one AP whose operating channel is one of the channels CH1, CH52, CH100, and CH144. For example, the score is adjusted by multiplying it by a value of 0.7 (taking the weighting factor as 0.7 as an example). This adjustment is made to reduce the likelihood that the wireless device 10 will select the AP corresponding to a channel that is different from the first channel CA(=CH36), thereby reducing the possibility of the wireless device 10 operating in the MCC mode/scenario. This is because the applicant has found that operating the wireless device 10 in MCC mode will lead to a decrease in performance due to its frequent channel switching. Hence, the second channel CB is determined as a channel corresponding to a highest score based on a plurality of updated scores. For example, the wireless device 10 selects a highest-scored AP from the plurality of APs based on a plurality of updated scores, thus, the operating channel of the highest-scored AP will be determined as the second channel CB, for example, CB=CH36. This enhancement channel selection algorithm can effectively prevent the wireless device 10 from operating in the MCC mode. After determining an appropriate second channel CB(=CH36) using the enhancement channel selection algorithm, the wireless device 10 can establish the second connection with the second communication device 12 through the second channel CB(=CH36), allowing the wireless device 10 to operate in SCC mode, thereby improving transmission latency and throughput in concurrent networks.

In the second case where the wireless device 10 comprises multiple RF transceiver paths, the wireless device 10 may decrease the at least one score corresponding to the at least one AP whose operating channel is different from the first channel CA and in the same frequency band as the first channel CA. This embodiment describes a scenario where the wireless device 10 comprises multiple RF transceiver paths, implying that it can also operate in dual-band dual-concurrent (DBDC) mode. In the DBDC mode, the wireless device 10 can transmit and receive data on two different frequency bands concurrently. In the proposed enhancement channel selection algorithm, to reduce interference and maintain optimal performance, the wireless device 10 may decrease the scores of APs operating on channels that are different from the first channel CA but in the same frequency band (for example, channels CH52, CH100, and CH144). This adjustment encourages the selection of APs operating on channels in a different frequency band than the first channel CA or on the same first channel CA, thereby making the wireless device 10 tend to operate in SCC mode or DBDC mode.

In one embodiment, the second network is a P2P network. In the P2P network, when the wireless device 10 intends to establish a P2P connection with the second communication device 12, the wireless device 10 negotiates with the second communication device 12 to acquire preferred channels, preferred channel lists and supported channel lists between the wireless device 10 and the second communication device 12, and the second channel for connection is determined based on the preferred channels, the preferred channel lists and the supported channel lists between the wireless device 10 and the second communication device 12. In one embodiment, if the wireless device 10 comprises only a single RF transceiver path, the preferred channel for the wireless device 10 is set to the first channel (i.e., the channel used by the existing connection). In another embodiment, if the wireless device 10 comprises multiple radio frequency (RF) transceiver paths, the preferred channel for the wireless device 10 is set to one of the first channel (such as CH 36) and a third channel (such as CH 149) which is different from the first channel and in a different frequency band from the first channel, and the preferred channel list for the wireless device 10 comprises the other of the first channel and the third channel. For example, during the negotiation process, the wireless device 10 and the second communication device 12 may determine which device will act as a role of Group Owner (GO) and which will act as a role of Group Client (GC). This decision can be based on factors like device capabilities, power levels, or user preferences. If the wireless device 10 is the GO, it may select the second channel CB based on its own preferred channel if the preferred channel for the wireless device 10 is also supported by the second communication device 12 (for example, the preferred channel for the wireless device 10 is also comprised in any one of the preferred channel, preferred channel list and supported channel list for the second communication device 12). Hence, the second channel CB for the connection may be determined as same as the first channel (such as CH36). This could enable the wireless device 10's SCC scenario where both connections operate on the same channel (CA=CB=CH36). In another embodiment, if the wireless device 10 comprises multiple radio frequency (RF) transceiver paths, the preferred channel for the wireless device 10 is set to one of the first channel and a third channel which is different from the first channel and in a different frequency band from the first channel, and the preferred channel list for the wireless device comprises the other of the first channel and the third channel. For example, in the case where the first channel is CH36, CH149 and CH36 are channels in different frequency bands and are FDD channels of each other. Therefore, the preferred channel of the wireless device 10 can be set to one (such as CH 149) of first channel (such as CH36) and third channel (such as CH149), and the preferred channel list for the wireless device 10 may comprise the other (such as CH 36) of the first channel (such as CH36) and third channel (such as CH149). If the wireless device 10 acts as the GO, it may select the second channel CB based on its own preferred channel if the preferred channel for the wireless device 10 is also supported by the second communication device 12 (for example, the preferred channel for the wireless device 10 is also comprised in any one of the preferred channel, preferred channel list and supported channel list for the second communication device 12). Hence, the second channel CB for the connection may be determined as the third channel (such as CH149). This could enable the wireless device 10's DBDC scenario where both connections operate on the channels in different frequency bands.

In the P2P network embodiment, the wireless device 10 and the second communication device 12 follow a series of steps to establish a P2P connection to enable the wireless device 10 operates in either the SCC or the DBDC mode (FDD mode) for optimal performance. In the SCC mode, the wireless device 10 maintains its existing connection on the first channel CA=CH36 with the first communication device 11 while simultaneously connecting to the second communication device 12 on the same channel (second channel CB=CH36). If the wireless device 10 supports the DBDC mode, the wireless device 10 can also establish the second connection with the second communication device 12 through another second channel CB (such as, CH149). These steps aim to optimize the P2P connection by selecting a channel that allows for either SCC or FDD mode, depending on the wireless device's hardware capabilities and preferences.

In one embodiment, the second network is a service access point (SAP) network. It is noted that the SAP network is a wireless network feature where one device can act as a wireless AP, and other devices can connect to it to share the network connection. Specifically, in the conventional connection process, the device that opens the hotspot scans all available channels and selects the best channel to establish the hotspot based on the regular channel selection algorithm. The selection criteria for the regular channel selection algorithm include channel quality, interference level, and security. However, in the proposed enhancement channel selection algorithm, the wireless device 10 directly determines the second channel CB without scanning, thereby guaranteeing the wireless device 10 to operate in the SCC mode or the DBDC mode. For example, if the wireless device 10 comprises only a single RF transceiver path, the second channel CB is directly determined to be the same as the first channel (i.e., CB=CA=CH36) without scanning. If the wireless device 10 comprises multiple RF transceiver paths, the second channel CB is determined to be one of the first channel CA and a third channel without scanning. Here, the third channel (such as CH149) is different from the first channel (CH36) and in a different frequency band from the first channel CA. It can be understood that the third channel and the first channel are FDD channels for each other. Similarly, by avoiding the MCC scenario, the second channel CB can be appropriately determined to make the wireless device 10 operate in the SCC mode and the DBDC mode for the wireless device 10 without scanning. As a result, through the enhancement channel selection algorithm, the channel management system 100 provides improved throughput and reduced latency, while saving scanning time and resources.

The purpose of the above embodiments is to appropriately select the second channel CB taking into account the existence of channels already used by existing connections, thereby increasing the likelihood that the wireless device 10 operates in SCC mode or DBDC mode, and reducing the probability of operating in MCC mode (where a single RF transceiver path is shared by at least two different channels). This can effectively avoid the drawbacks of increased latency and throughput caused by the MCC mode. The enhancement channel selection algorithm can be listed in Table T1, and it should be noted that Table 1 only uses the key parts of the enhancement channel selection algorithm as an example.

TABLE T1

| Network Type | Enhancement channel selection algorithm |
|---|---|
| STA-to-AP network | scan and choose the highest-scored AP: |
| | (a) When the scanned channel turns the wireless |
| | device into an MCC scenario, the score of this |
| | channel is adjusted by multiplying it by a value |
| | of a weighting factor (such as 0.7). |
| P2P network | provide preference information for negotiation: |
| | (a) Preferred channel (select SCC or FDD channel) |
| | (b) Preferred channel list (Prioritize SCC or FDD |
| | channel) |
| | (c) Supported channel list |
| SAP network | Directly select SCC or FDD channel without scan. |

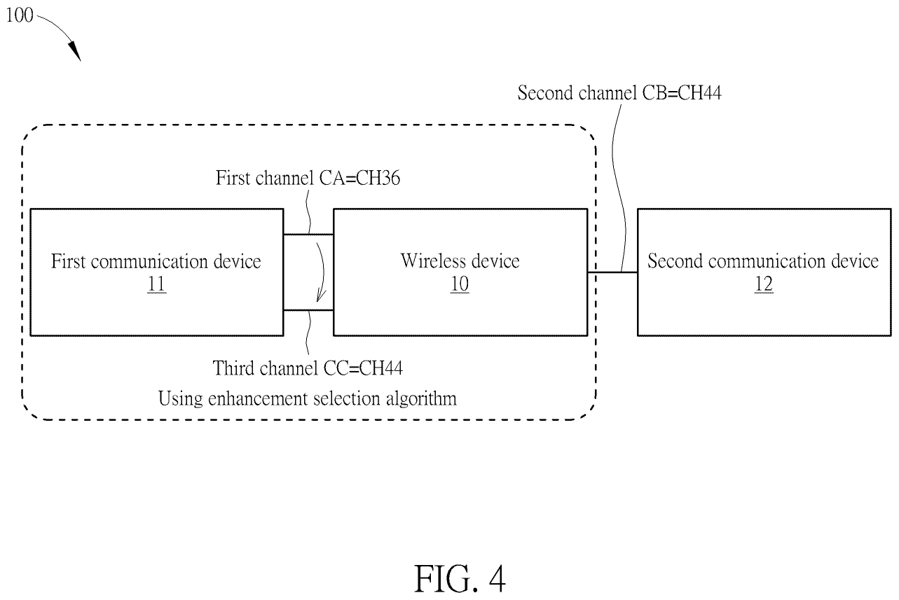

FIG. 4 is a schematic diagram of switching the first channel CA to the third channel CC of the channel management system 100. In FIG. 4, the wireless device 10 is already operated in the MCC scenario, which can lead to reduced performance. There are several reasons why the system might enter the “MCC scenario”. For example, in some embodiments, after the first channel CA is configured, if the user interface or framework may not allow the second channel CB in the second network to be dynamically assigned or changed, leading to the MCC scenario. In another case, after the first channel CA is configured, if the user manually forces the wireless device 10 to connect to a specific channel as the second channel CB, it may lead to the MCC scenario since other networks are already operating on the first channel CA different from the second channel CB. In other embodiments, even with the enhancement channel selection algorithm, if the available APs are limited, the wireless device 10 may still connect to an AP that causes the MCC scenario (i.e., a decreased score may still be the highest score). Therefore, for the scenario where the wireless device 10 operates in the MCC mode, the embodiment of the present invention also provides a switching mechanism (i.e., after considering the existence of the channel used by the later established connection, the channel used by the earlier established connection is switched to another channel, similar to the enhanced signal selection algorithm described above.) to enable the site device 10 to switch from the MCC mode to the SCC mode or the DBDC mode. For ease of explanation and understanding, FIG. 4 is illustrated by taking the example that the wireless device 10 comprises only a single transceiver path.

In FIG. 4, initially, the wireless device 10 is linked to the first communication device 11 in the first network through the first channel CA(=CH36) and is linked to the second communication device 12 in the second network through the second channel CB(=CH44), which may result in the MCC scenario for the wireless device 10. When the wireless device 10 operates in the MCC mode/scenario, the channel management system 100 (specifically, the wireless device 10) can be triggered to perform a reassess flow. In the reassess flow, the channel management system 100 can improve performance by changing from the MCC scenario to the SCC scenario or dual-band dual-concurrent (DBDC) scenario. The concurrent networks will use their existing protocols to switch the “original” first channel CA to a different channel, such as the third channel CC. In the following, embodiments provide specific protocols used for different types of networks, as illustrated below.

In one embodiment, at least one of the first network and the second network is the STA-AP network. For example, the first network is the STA-AP network. In this example, when the wireless device 10 operates in the MCC mode, the wireless device 10 may send a reassociation request frame to a third communication device (for example, another AP, not shown in FIG. 4). Then, the wireless device 10 may receive a reassociation response frame sent from the third communication device if the reassociation request frame is accepted. In the embodiment, if the wireless device 10 comprises only a single RF transceiver path, the first channel CA(=CH36) may be switched to the third channel CC which is the same with the second channel CB(=CH44) so that the wireless device 10 will operate in the SCC mode. In another embodiment, if the wireless device has multiple RF transceiver paths, the first channel CA(=CH36) may be switched to the third channel CC(=CH149) which is different from the second channel CB(=CH44) and in a different frequency band from the second channel so that the wireless device 10 will operate the DBDC mode; alternatively, the first channel CA(=CH36) may be switched to the third channel CC(=CH44) which is same as the second channel CB(=CH44) so that the wireless device 10 will operate the SCC mode. In the embodiment, the third channel may be determined by the enhancement channel selection algorithm that takes into account the channel of the existing connection (i.e., the second channel CB in this scenario), and the operating channel of the third communication device (for example, with the highest score) comprises the third channel. In brief, when the wireless device 10 is operated in the MCC mode, an operating channel in the STA-AP network can be switched through a reassociation procedure in the STA-AP network so as to preferably switch the wireless device 10 operated from the MCC mode to the SCC mode or the DBDC mode. As a result, the channel management system 100 can provide a more efficient, faster, and potentially more energy-efficient network experience.

In one embodiment, at least one of the first network and the second network is a peer-to-peer (P2P) network, and, when the wireless device 10 is operated in MCC mode, the wireless device 10 may switch an operating channel in the P2P network through a Channel Switch Request and Announcement mechanism (which has been defined in current Wi-Fi Direct protocol) so as to switch the wireless device 10 operated from the MCC mode to the SCC mode or DBDC mode. For example, when the wireless device 10 is operated in MCC mode, the first communication device 11 may be triggered to generate an extended channel switch announcement (ECSA)/CSA frame carrying information about the third channel CC (for example, CC=CB=CH44) to make the wireless device 10 operate in SCC mode. The ECSA frame is a signal that is used to advertise when the basic service set (BSS) is changing to a new channel in the same or a new operating class. The ECSA/CSA frame includes both the operating class and the channel number of the new channel. The ECSA/CSA element is comprised in the ECSA/CSA frame, and the format of the ECSA/CSA element is shown in Table T2.

TABLE T2

| | | | Channel | New | New | Channel |
|---|---|---|---|---|---|---|
| | Element | | Switch | Operating | Channel | Switch |
| Field | ID | Length | Mode | Class | Number | Count |
| Octets | 1 | 1 | 1 | 1 | 1 | 1 |

The wireless device 10 may receive the ECSA/CSA frame transmitted from the first communication device 11. As previously mentioned, for the wireless device 10 and the first communication device 11, either device can assume the role of Group Owner (GO) or Group Client (GC). The GO acts as the central coordinator, similar to an AP, while the GC connects to the GO. In the embodiment, the GO may switch the first channel CA to the third channel CC which is the same as the second channel CB through the ECSA/CSA frame. For example, the GO switches the “original” first channel CA(=CH36) to the third channel CC=CH44 through ECSA frame, thus, the wireless device 10 is switched from the MCC scenario to the SCC scenario (CB=CC=CH44). Similarly, in another embodiment, when the wireless device 10 is operated in the MCC mode, an operating channel in the P2P network is switched through a Channel Switch Request and Announcement mechanism in the P2P protocol so as to switch the wireless device 10 operated from the MCC mode to the DBDC mode. By doing so, the wireless device 10 can use different channels and different transceiver paths to transmit signals.

In one embodiment, at least one of the first and second network is a service access point (SAP) network. When the wireless device 10 is operated in the MCC mode, an operating channel in the SAP network can be switched through a Channel Switch Request and Announcement mechanism so as to switch the wireless device 10 from the MCC mode to the SCC mode or the DBDC mode. The first channel CA is switched to the third channel CC between the wireless device 10 and the first communication device 11 based on an extended channel switch announcement (ECSA)/CSA. For example, the wireless device 10 switches the first channel CA(=CH36) to the third channel CC(=CH44) for operating in the SCC mode, or switches the first channel CA(=CH36) to the third channel CC(=CH149) for operating in the DBDC mode between the wireless device 10 and the first communication device 11 based on the ECSA. In the embodiment, the ECSA allows for a coordinated channel switch within the SAP network, enabling a seamless transition from the MCC scenario to the SCC scenario or the FDD scenario for improved performance.

In the above embodiment, when the wireless device 10 operates in the MCC mode, the third channel may be determined through the enhancement channel selection algorithm that takes into account the existence of channels used by existing connections in other networks. The purpose of the above embodiments is to preferably transform the MCC scenario caused by a single RF transceiver path shared by two different channels (CA and CB) into the SCC scenario or the FDD scenario by appropriately switching the first channel CA to the third channel CC. This can reduce transmission delays and increase throughput. The change AP/channel protocol message can be listed in Table T3.

TABLE T3

| Network Type | Change AP/Channel Protocol Message |
|---|---|
| STA-to-AP network | (a) Send a reassociation request frame to AP |
| | (b) Receive a reassociation response from the AP |
| | (if accepted) |
| P2P network | ECSA/CSA |
| SAP network | ECSA/CSA |

The advantage of the wireless device 10 converting the MCC scenario to the SCC scenario or FDD scenario is evident in terms of latency and throughput performance. In the channel management system 100, for an embodiment, the “channel switch time=3.5 ms” and “MCC quota time=50 ms” are pre-conditioned. For the channel switch time, it takes 3.5 milliseconds for the wireless device 10 (e.g., a mobile phone) to switch from one Wi-Fi channel to another. This is a crucial parameter since frequent channel switching can introduce overhead and latency. For the MCC quota time, it assumes that in the MCC scenario, where the wireless device 10 is connected to two networks on different channels. Each network is allocated a 50-millisecond time quota for data transmission. After this quota is exhausted, the wireless device 10 switches to the other channel, incurring a channel switch time overhead. For the MCC scenario, the average latency is 23 milliseconds. The maximum latency is 55 milliseconds. The total throughput (T-put) of the channel management system 100 when using the MCC mode is 7% lower than the highest T-put achieved when using a single channel (SCC mode).

For the SCC scenario or the DBDC scenario, the latency is reduced to 5 milliseconds. The average latency improvement can reach up to 78%. The maximum latency improvement can reach up to 90%. This is because when the wireless device 10 operates in the SCC or DBDC mode, it can eliminate the need for channel switching and reduce latency. Further, the total T-put achieved when operating in SCC mode is equivalent to the peak T-put. Furthermore, this total T-put is 7% higher than operating in MCC mode. Further, the wireless device 10 operating in the DBDC mode achieves a total T-put that is double the peak T-put. This enhancement translates to a 115% increase in T-put compared to the SCC scenario. The significant throughput enhancement in DBDC mode is attributed to the wireless device's ability to utilize two separate frequency bands concurrently. This simultaneous operation effectively doubles the available bandwidth for data transmission, leading to a substantial increase in overall throughput.

In the channel management system 100, when there are more than two networks (e.g., 3), the selection of the new channel will refer to the settings of previous channels used by existing connections (e.g., the existence of first two channels used by two existing connections is taken into account), and give priority to maintaining the SCC mode or the DBDC mode. If the first two channels already meet the requirements for the SCC scenario or the FDD scenario, the new channel will be selected based on the same concept. For example, if the first two channels have used the same channel (e.g., CA=CB=CH36), the new channel can be determined as the same channel (e.g., CH36) to maintain the SCC scenario. If the first two channels use different frequency bands under the DBDC scenario (e.g., CA=36 and CB=CH149), the new channel can be determined as another channel in a different frequency band from the first two channels to achieve the DBDC mode or determined as one of the first two channels to achieve the DBDC/SCC mode, depending on hardware capabilities of the wireless device 10. In short, the selection of the new channel will try to maintain the SCC or FDD scenario to improve overall performance and reduce latency.

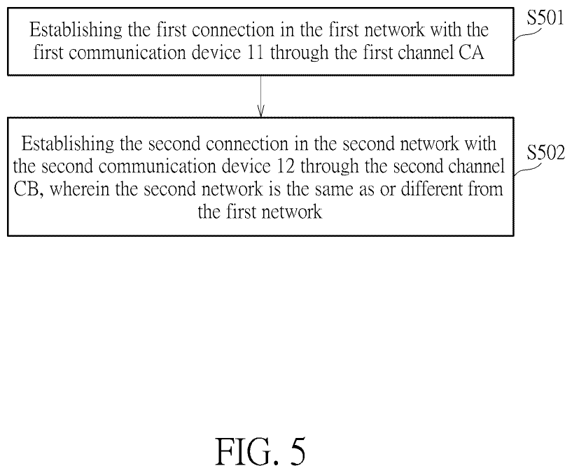

FIG. 5 is a flow chart of performing a channel management method for concurrent networks by the wireless device 10. The channel management method for concurrent networks includes step S501 to step S502. Any technology or hardware modification falls into the scope of the embodiments. Step S501 to step S502 are illustrated below.
Step S501: establishing the first connection in the first network with the first communication device 11 through the first channel CA;
Step S502: establishing the second connection in the second network with the second communication device 12 through the second channel CB, wherein the second network is the same as or different from the first network.

Details of step S501 to step S502 are previously illustrated. Thus, they are omitted here. The channel management system 100 can optimize Wi-Fi network performance in scenarios where multiple networks are operating concurrently. The channel management system 100 achieves improved performance by employing the enhancement channel selection algorithm to reduce the possibility of the MCC scenario when choosing an AP or an appropriate channel for a new network connection. The enhancement channel selection algorithm prioritizes the SCC scenario or DBDC scenario, where networks operate on the same channel and the same band, or different channels and different bands, respectively, to reduce channel switching, and latency.

In summary, the embodiments disclose a channel management system and a channel management method for concurrent networks. The channel management system and method aim to address the issue of the MCC scenarios in Wi-Fi networks, where a single RF transceiver path shared by two different channels leads to reduced throughput and increased latency. The technical concept is to prioritize SCC or DBDC scenarios when determining a channel for a new network connection. This approach aims to reduce channel switching overhead and interference by establishing the connections through the same channel (corresponding to SCC mode) or different channels on different frequency bands (corresponding to DBDC mode). This is achieved through the enhancement channel selection algorithm that considers the existence of previous channels used by existing connections when determining the channel for the new network connection, reducing the risk of falling into MCC scenario. Thus, the channel management system and method result in several advantages, including reduced latency, improved throughput, and enhanced overall system performance in multi-network concurrent scenarios.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A channel management method for concurrent networks, performed by a wireless device, comprising:
establishing a first connection in a first network with a first communication device through a first channel; and
establishing a second connection in a second network with a second communication device through a second channel, wherein the second network is the same as or different from the first network,
wherein the second channel is determined by an enhancement channel selection algorithm that takes into account the existence of the first channel through which the first connection has been established.

2. The method of claim 1, wherein the second network is a station-to-access point (STA-AP) network, and the method further comprises:
performing a scan operation to discover a plurality of APs, wherein each of the plurality of APs has a corresponding operating channel;
generating a plurality of scores corresponding to the plurality of APs according to a regular channel selection algorithm which does not take into account the existence of the first channel, wherein each of the plurality of scores is associated with a corresponding AP and a corresponding channel; and
adjusting at least one score of the plurality of scores corresponding to at least one AP based on the first channel, to update the plurality of scores;
wherein the second channel is determined as a channel corresponding to a highest score based on a plurality of updated scores.

3. The method of claim 2, wherein adjusting the at least one score corresponding to the at least one AP based on the first channel comprises:
decreasing the at least one score corresponding to the at least one AP based on a weighting factor, wherein the weighting factor is greater than 0 and less than 1.

4. The method of claim 3, wherein adjusting the at least one score corresponding to the at least one AP based on the first channel further comprises:
decreasing the at least one score corresponding to the at least one AP whose operating channel is different from the first channel, if the wireless device comprises only a single RF transceiver path; or
decreasing the at least one score corresponding to the at least one AP whose operating channel is different from the first channel and in the same frequency band as the first channel, if the wireless device comprises multiple RF transceiver paths.

5. The method of claim 1, wherein the second network is a peer-to-peer (P2P) network, and the wireless device comprises only a single RF transceiver path, and the method further comprises:
acquiring preferred channels, preferred channel lists, and supported channel lists between the wireless device and the second communication device, wherein the preferred channel for the wireless device is set to the first channel,
wherein the second channel is determined based on the preferred channels, the preferred channel lists and the supported channel lists between the wireless device and the second communication device.

6. The method of claim 1, wherein the second network is a peer-to-peer (P2P) network, the wireless device comprises multiple radio frequency (RF) transceiver paths, and the method further comprises:
acquiring preferred channels, preferred channel lists, and supported channel lists between the wireless device and the second communication device, wherein the preferred channel for the wireless device is set to one of the first channel and a third channel which is different from the first channel and in a different frequency band from the first channel, and the preferred channel list for the wireless device comprises the other of the first channel and the third channel,
wherein the second channel is determined based on the preferred channels, the preferred channel lists and the supported channel lists between the wireless device and the second communication device.

7. The method of claim 1, wherein the second network is a service access point (SAP) network, and
wherein if the wireless device comprises only a single RF transceiver path, the second channel is determined to be the same as the first channel without scanning; or
if the wireless device comprises multiple RF transceiver paths, the second channel is determined to be one of the first channel and a third channel without scanning, wherein the third channel is different from the first channel and in a different frequency band from the first channel.

8. The method of claim 1, wherein at least one of the first and second network is a station-to-access point (STA-AP) network, and the method further comprises:
when the wireless device is operated in a Multiple Channel Concurrent (MCC) mode, switching an operating channel in the STA-AP network through a reassociation procedure to switch the wireless device operated from the MCC mode to a Single Channel Contention (SCC) mode or a Dual band Dual Concurrent (DBDC) mode.

9. The method of claim 1, wherein at least one of the first and second network is a peer-to-peer (P2P) network, and the method further comprises:
when the wireless device is operated in an MCC mode, switching an operating channel in the P2P network through a Channel Switch Request and Announcement mechanism to switch the wireless device operated from the MCC mode to a Single Channel Contention (SCC) mode or a Dual band Dual Concurrent (DBDC) mode.

10. The method of claim 1, wherein at least one of the first and second network is a service access point (SAP) network, and the method further comprises:
when the wireless device is operated in an MCC mode, switching an operating channel in the SAP network through a Channel Switch Request and Announcement mechanism to switch the wireless device operated from the MCC mode to a Single Channel Contention (SCC) mode or a Dual band Dual Concurrent (DBDC) mode.

11. A wireless device comprising:
at least one transceiver configured to wirelessly communicate; and
a processor coupled to the at least one transceiver and configured to perform operations comprising:
establishing a first connection in a first network with a first communication device through a first channel; and
establishing a second connection in a second network with a second communication device through a second channel, wherein the second network is the same as or different from the first network;
wherein the second channel is determined by an enhancement channel selection algorithm that takes into account the existence of the first channel through which the first connection has been established.

12. The wireless device of claim 11, wherein the second network is a station-to-access point (STA-AP) network, and the processor is further configured to perform operations comprising:
performing a scan operation to discover a plurality of APs, wherein each of the plurality of APs has a corresponding operating channel;
generating a plurality of scores corresponding to the plurality of APs according to a regular channel selection algorithm which does not take into account the existence of the first channel, wherein each of the plurality of scores is associated with a corresponding AP and a corresponding channel; and
adjusting at least one score of the plurality of scores corresponding to at least one AP based on the first channel, to update the plurality of scores;
wherein the second channel is determined as a channel corresponding to a highest score based on a plurality of updated scores.

13. The wireless device of claim 12, wherein adjusting the at least one score of the plurality of scores corresponding to the at least one AP based on the first channel comprises:
decreasing the at least one score corresponding to the at least one AP based on a weighting factor, wherein the weighting factor is greater than 0 and less than 1.

14. The wireless device of claim 13, wherein adjusting the at least one score corresponding to the at least one AP based on the first channel further comprises:
decreasing the at least one score corresponding to the at least one AP whose operating channel is different from the first channel, if the wireless device has only a single RF transceiver path; or
decreasing the at least one score corresponding to the at least one AP whose operating channel is different from the first channel and in the same frequency band as the first channel, if the wireless device comprises multiple RF transceiver paths.

15. The wireless device of claim 11, wherein the second network is a peer-to-peer (P2P) network, and the wireless device comprises only a single RF transceiver path, preferred channels, preferred channel lists, and supported channel lists between the wireless device and the second communication device are acquired by the wireless device, the preferred channel for the wireless device is set to the first channel, and the second channel is determined based on the preferred channels, the preferred channel lists and the supported channel lists between the wireless device and the second communication device.

16. The wireless device of claim 11, wherein the second network is a peer-to-peer (P2P) network, the wireless device comprises multiple radio frequency (RF) transceiver paths, preferred channels, preferred channel lists, and supported channel lists between the wireless device and the second communication device are acquired by the wireless device, the preferred channel for the wireless device is set to one of the first channel and a third channel which is different from the first channel and in a different frequency band from the first channel, the preferred channel list for the wireless device comprises the other of the first channel and the third channel, the second channel is determined based on the preferred channels, the preferred channel lists and the supported channel lists between the wireless device and the second communication device.

17. The wireless device of claim 11, wherein the second network is a service access point (SAP) network, if the wireless device comprises only a single RF transceiver path, the second channel is determined to be the same as the first channel without scanning, or if the wireless device comprises multiple RF transceiver paths, the second channel is determined to be one of the first channel and a third channel without scanning, and the third channel is different from the first channel and in a different frequency band from the first channel.

18. The wireless device of claim 11, wherein at least one of the first and second network is a station-to-access point (STA-AP) network, when the wireless device is operated in a Multiple Channel Concurrent (MCC) mode, an operating channel in the STA-AP network is switched through a reassociation procedure to switch the wireless device operated from the MCC mode to a Single Channel Contention (SCC) mode or a Dual band Dual Concurrent (DBDC) mode.

19. The wireless device of claim 11, wherein at least one of the first and second network is a peer-to-peer (P2P) network, when the wireless device is operated in an MCC mode, an operating channel in the P2P network is switched through a Channel Switch Request and Announcement mechanism to switch the wireless device operated from the MCC mode to a Single Channel Contention (SCC) mode or a Dual band Dual Concurrent (DBDC) mode.

20. The wireless device of claim 11, wherein at least one of the first and second network is a service access point (SAP) network, when the wireless device is operated in an MCC mode, an operating channel in the SAP network is switched through a Channel Switch Request and Announcement mechanism to switch the wireless device operated from the MCC mode to a Single Channel Contention (SCC) mode or a Dual band Dual Concurrent (DBDC) mode.
